(19) United States
(12) Patent Application Publication
(10) Pub. No.: US 2025/0331539 A1
(43) Pub. Date: Oct. 30, 2025

(54) METHOD AND DEVICE FOR PRODUCING A SUSPENSION

(71) Applicant: IVAN MALLINOWSKI, Wassenberg (DE)

(72) Inventor: IVAN MALLINOWSKI, Wassenberg (DE)

(21) Appl. No.: 19/081,146

(22) Filed: Mar. 17, 2025

Related U.S. Application Data
(63) Continuation of application No. PCT/EP2023/076933, filed on Sep. 28, 2023.

(30) Foreign Application Priority Data
Sep. 30, 2022 (DE) 102022003642.8
Mar. 16, 2023 (DE) 102023106580.7

(51) Int. Cl. A23L 2/72; A23N 1/02

(52) U.S. Cl. CPC A23L 2/72; A23N 1/02; A23V 2002/00; A23V 2300/31

(57) ABSTRACT

A method for producing a suspension, the method including feeding water by a pump from a storage container through a mixing chamber; mechanically comminuting plant parts from real nuts, kernels, grains, and/or seeds by a comminuting element to form comminuted plat parts; mixing the comminuted plant parts with the water in the mixing chamber to form a mix; pressing the mix through a filter that passes the suspension through and retains a pomace that remains from the plant parts, wherein a pump wheel of the pump forms the comminuting element.

### RELATED APPLICATIONS

This application is a continuation of international patent application PCT/EP2023/076933, filed on Sep. 28, 2023, claiming priority from German patent application DE 10 2022 003 642.8, filed on Sep. 30, 2022, and German patent application DE 10 2023 106 580.7, filed on Mar. 16, 2023, all of which are incorporated in their entireties by this reference.

### FIELD OF THE INVENTION

The invention relates to a method and a device for producing a suspension.

### BACKGROUND OF THE INVENTION

A generic method and a device are known from DE 10 2021 104 742 B3. The generic method mechanically comminutes the plant parts in the mixing chamber. Freshness of the plant parts and the vitamins and nutrients included therein are thus maintained until directly before producing the suspension.

### BRIEF SUMMARY OF THE INVENTION

Thus, it is an object of the invention to simplify the device recited supra.

Improving upon the known method, it is proposed according to the invention to configure the pump wheel of the pump as the comminuting element. Since the pump wheel performs the function of the comminuting element, no additional drive for the comminuting element is required. Thus, the device is simplified significantly.

The object is achieved by a method for producing a suspension, wherein water is fed by a pump from a storage container through a mixing chamber and plant parts from real nuts, kernels, grains, and/or seeds are mechanically comminuted by comminuting element and mixed with the water in the mixing chamber and the mix is pressed through a filter that passes the suspension through and retains a pomace that remains from the plant parts.

The object is also achieved by a device for producing a suspension, the device comprising a comminuting element for comminuting plant parts from real nuts, kernels, grains, and/or other seeds, a mixing chamber for mixing the comminuted plant parts with water, a filter that passes the suspension through and retains a pomace remaining from the plant parts, and a pump for pressing the water from a storage container through the mixing chamber and the filter.

Pumps including a pump wheel are known in the art as centrifugal pumps. Centrifugal pumps are particularly simple and robust turbo machines including a rotating shaft and that use dynamic forces for feeding the mix of water and plant parts. The configuration as a radial pump, thus with a radial exit from the pump enhances the centrifugal effect of the pump wheel.

Advantageously, the suspension flows from the mixing chamber directly into a capture container according to the method according to the invention. After producing the suspension, the capture container can be used as a table or drinking container for the suspension. The suspension can be run continuously into a filling plant in an industrial process.

The storage container simultaneously functions as a capture container in a method according to the invention. Thus, the plant parts are mixed with a defined water volume in the production cycle.

Advantageously, the plant parts are pressed into a tablet shape according to the method according to the invention and dried and the tablet is introduced into the mixing chamber and comminuted by the comminuting element.

Improving upon the known device, it is proposed according to the invention that a pump wheel of the pump is configured as the comminuting element. The device according to the invention facilitates performing the method according to the invention and is therefore characterized by its advantages described supra.

The device according to the invention can be configured in particular as an accessory for a typical hand blender or tabletop blender. Alternatively, a device according to the invention can include an integrated drive.

Advantageously, the comminuting element in the device according to the invention is a rasp. The rasp can be integrally formed with the pump wheel and configured from stainless steel or oxide ceramics or can be glued to a plastic base element of the pump wheel. Stainless steel and oxide ceramics have particularly low wear. The rasp can include radial or spiral teething. Alternatively, a rasp without uniform teething can be made from food grade abrasive paper.

Additional cutting, grinding, and rasp surfaces can be configured at an inside of the housing, at the filter and/or at the pump wheel in order to continuously comminute the pulp.

The filter in a device according to the invention is advantageously configured as a gap with a gap dimension of 0.5 mm at the most. The gap retains portions of the suspension that exceed the gap size and thus functions as a filter. When the gap is formed in a radial direction between the pump wheel and the housing, the pump wheel generates a radial flow in the gap due to adhesion and viscosity of the suspension according to a Tesla pump principle. The flow cross section of the filter determines the dwelling time of the suspension in the mixing chamber. The gap has a height of 0.2 mm at the most. Thereafter, the suspension is ready to drink when exiting the filter. Alternatively, the suspension can be run through one or plural additional filter stages after exiting the filter.

Alternatively, the device according to the invention advantageously includes a filter configured as a perforated metal plate. The perforated metal plate is easily adaptable to the method according to the invention by selecting a number and geometry of the holes. The holes can include a taper in order to prevent clogging. The smooth surface of the metal plate facilitates cleaning. Alternatively, the filter can be a wire sieve, a cloth or a fleece or a combination of these alternatives.

Further advantageously, the pump wheel defines the gap in the device according to the invention. The suspension is pressed through the gap directly by the pump wheel at the tightest location of the gap and through the comminuted plant parts since the pump wheel simultaneously functions as the comminuting element.

The mixing chamber includes a constant cross section that has finite number of rotation symmetries about the vertical axis in a device according to the invention. A portion of the plant parts adapted in cross section to the mixing chamber and shaped like a tablet is prevented from rotating about the axis direction through positive form locking. Further advantageously, the cross-section symmetry is sextuple at the most. The tuple number is the number of predetermined rotation angles of less than 360 degrees about a central axis in which a geometric figure is mapped on itself.

Advantageously, the device according to the invention includes a drive element axially movable in the mixing chamber and substantially closing the mixing chamber below the plant parts. The drive element can include a sabot. The pump then sucks in the sabot which pushes the plant parts upward into the mixing chamber. The sabot can include one or plural cutouts, wherein the water can flow through the cutouts from the storage container into the mixing chamber. In particular, a tablet pressed from the plant parts can include channels corresponding to the cutouts, wherein the channels run the water to the top side of the mixing chamber.

Alternatively, the plant parts can be inserted as an accordingly configured tablet which is sucked in by the pump due to its shape in a simplified device according to the invention that does not include the sabot. The tablet can include a radially protruding edge at a bottom, wherein the radially protruding edge is retained as a residual by an advantageously flexible constriction of the mixing chamber without falling back into the storage container. Additionally, a tablet of this type can include a funnel shaped opening at a bottom along the axis so that only an outer edge of the tablet remains and gets sucked in at the end of the process.

The drive, a housing with the mixing chamber, the pump wheel, and/or the storage container are advantageously connected by quick connects, in particular, snap connections, clamped connections, bracket connections, magnet or bayonetted connections in a device according to the invention. Thus, the individual components can be easily separated manually, cleaned after use, and assembled again.

The device according to the invention can include a variable flow limiter for the suspension exiting from the filter. The flow limiter can include in particular one or plural gaps with an adjustable width and/or length. The dwelling time of the mix in the mixing chamber can then be individually adjusted for different suspensions.

Advantageously, the plant parts are configured as lumps in the method according to the invention. The lumps are individual pieces having an original macroscopic structure of the plant parts, in particular with grain sizes at least partially in a millimetre range or greater. Lumps according to this application are whole or shredded nuts, grains, and additional seeds.

Advantageously, the plant parts according to the method according to the invention are pressed into a shape of a tablet and are subsequently ground off from the tablet and flushed to the filter by the water. The tablet shape simplifies dosing and improves storability of the plant parts.

Advantageously, the plant parts according to the method according to the invention are air dried, rough shredded, malted, or roasted, at least partially decomposed by enzymes, and/or sweetened. Air drying saves the valuable contents of the plant parts. Alternatively, other drying methods, in particular, freeze drying, can be used. Freeze drying shortens the drying process significantly. Advantageously, the plant parts according to the method according to the invention are at least partially soaked in water before drying. The plant parts swell in the pulp and can thus be processed more easily. The swelling can be supported by slightly heating the pulp to 50 to 60 degrees C.

Further advantageously, the plant parts are dried in an inert atmosphere, in particular under nitrogen. Thus, introducing germs into the plant parts during drying is prevented.

Shredding on the one hand side accelerates precise portioning in particular large nuts, kernels, grains, or seeds, and comminuting during production of the beverage. Alternatively, entire nuts, kernels, grain seeds, and other seeds can be bound in the tablet.

Decomposing adapts insoluble contents of the plant parts so that they are distributed in water more easily. The plant parts can be steamed, roasted, germinated, or fermented.

Sweetening improves the taste of the beverage. In particular, starch and long chain sugars like glucose can be decomposed in the plant parts by enzymes and converted into short chain sugars like fructose or sweeteners can be added. Advantageously, the plant parts in a method according to the invention include dry components like shells, spelts, or beards. The dry components facilitate self-cleaning of the filter through the mix flowing through the filter.

Advantageously, a binder, an emulsifier, an oil, a fat, and/or salt is added to the suspension according to the method according to the invention. A binder improves shape retention of a portion of the plant parts. Plant binders, like starch or guar gum, are particularly suitable. The emulsifier prevents de-mixing of the suspension produced. Lecithin is a particularly suitable emulsifier. Oil increases a fat content of the suspension and forms an emulsion together with the water, wherein the emulsion produces a haptic sensation similar to natural animal milk. The oil can be mixed with the plant parts or added in one or plural capsules that are mechanically comminuted when producing the suspension with the plant parts. Sugar, sugar-free sweeteners, and salt improve storability of the tablet and function as a taste-enhancing agent in the suspension.

### BRIEF DESCRIPTION OF THE DRAWINGS

The invention is subsequently described based on advantageous embodiments with reference to drawing figures, wherein:

FIG. 1A/B illustrates a first device according to the invention, being prepared for a method according to the invention;

FIG. 2A/B/C shows the device according to FIG. 1 while performing the method;

FIG. 3A/B shows the device according to FIG. 1 taken apart into individual components;

FIG. 4A/B shows a second device according to the invention while preparing another method according to the invention;

FIG. 5A/B shows the device according to FIG. 4 while performing the method;

FIG. 6A/B shows the device according to FIG. 4 broken down into individual components;

FIG. 7A shows the first device according to the invention;

FIG. 7B shows an exploded view of the first device;

FIG. 7C shows a sectional view of the first device;

FIG. 7D shows a detail of the sectional view of the first device;

FIG. 8A shows the second device according to the invention;

FIG. 8B shows a sectional view of the device according to the invention;

FIG. 8C shows the individual components of the second device;

FIG. 8D shows an exploded view of the second device;

FIG. 9A shows the third device according to the invention;

FIG. 9B shows a sectional view of the third device; and

FIG. 9C shows individual components of the third device.

### DETAILED DESCRIPTION OF THE INVENTION

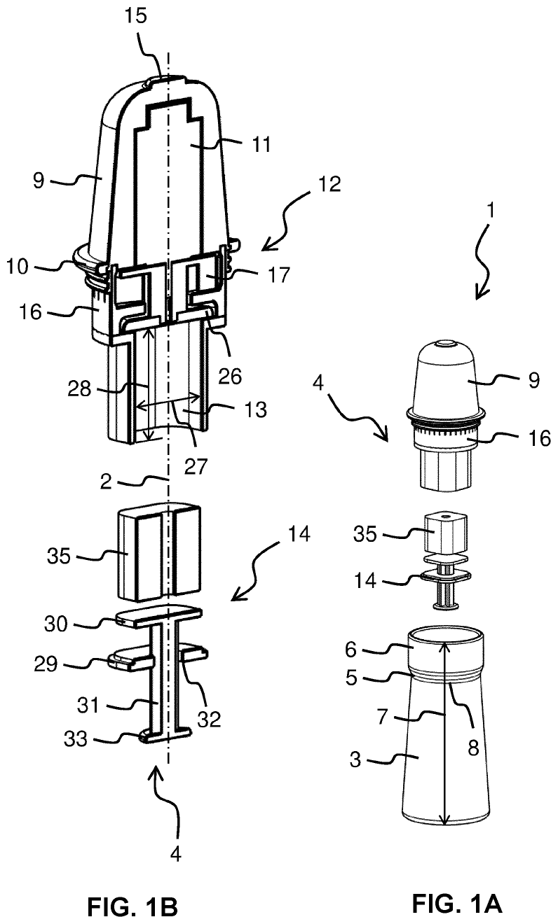

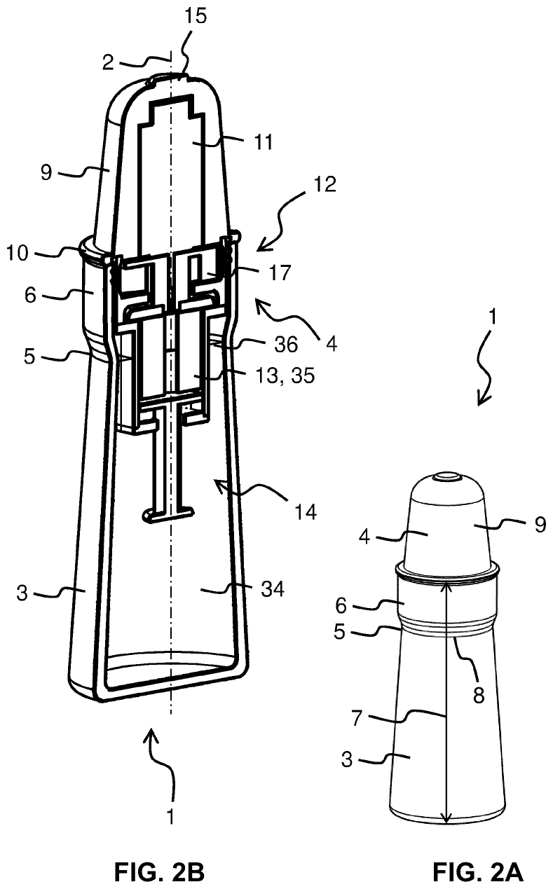

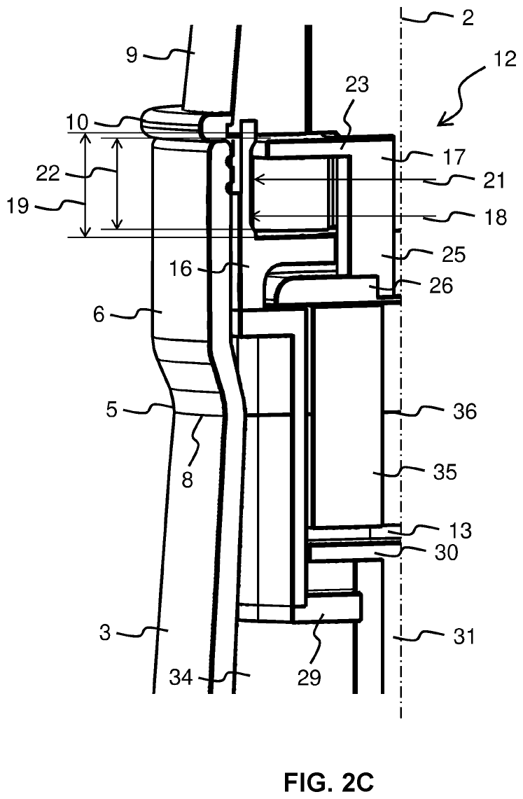

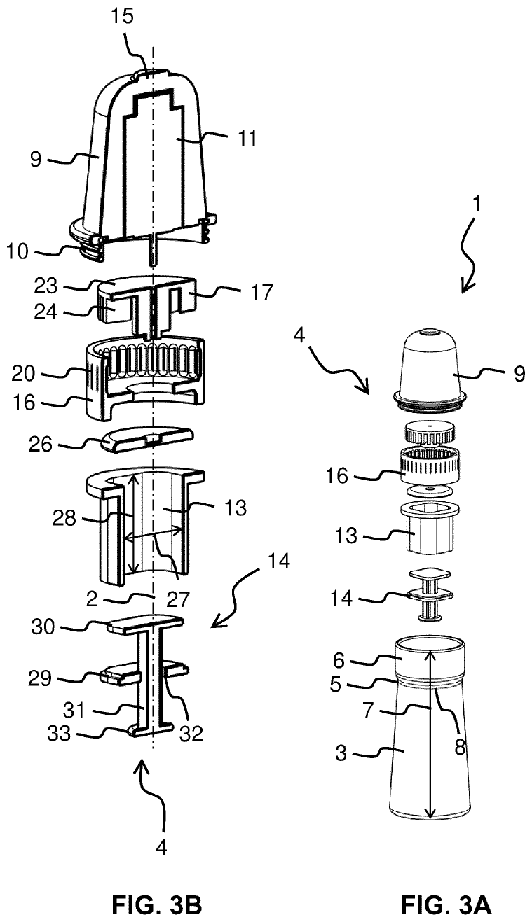

The first device 1 according to the invention shown in FIG. 1A in a perspective view from above in an open condition is rotation symmetrical about a vertical axis 2. The device 1 includes a glass storage container 3 and a mixing unit 4 arranged above the storage container 3 cut along the vertical axis 2 in FIG. 1A. The closed device 1 is shown in FIG. 2A and in FIG. 2B cut along the vertical axis 2 and illustrated in detail in FIG. 2C. FIG. 3A and a cut view detail in FIG. 3B show individual components of the device 1 in an exploded view.

The storage container 3 initially tapers upward in a conical shape towards a gripping recess 5 and terminates in a cylindrical rim 6 slightly expanded relative to the gripping recess 5. The storage container 3 includes a height 7 of 23 centimeters and a volume of 1,000 ccm up to a filling mark 8. The mixing unit 4 is made from a bell-shaped housing 9 with an annular seal 10 towards the storage container 3, a drive 11, a pump 12 driven by the drive 11, a mixing chamber 13, and a drive element 14. The drive 11 is an electric motor with a power of 600 W and is supplied with energy by a non-illustrated cable. A key switch 15 configured for switching the drive 11 on and off is arrange atop of the housing 9.

The pump 12 is a radial pump with a cylindrical housing 16 and a pump wheel 17 driven by the drive 11 to rotate about the vertical axis 2. The housing 16 has an inner diameter 18 of 70 mm and a height 19 of 14 mm and 32 vertically extending pass through openings 20 leading radially outward. A filter is fixed at the housing 16 upstream from the pass through openings 20. The filter is made from a stainless steel mesh. The pump wheel 17 has a diameter 21 of 64 mm and a height 22 of 12 mm and 24 radially extending blades 24 formed under a disc 23.

The pump wheel 17 includes a spout 25 arranged centrally between the blades 24 and penetrating the housing 16 in a downward direction, wherein a plate shaped comminuting element 26 is arranged at the spout 25. The comminuting element 26 is configured as a rasp with spiral teething at a bottom side. The mixing chamber 13 includes a square cross section with an edge length 27 of 44 mm and rounded corners and a height 28 of 57 mm.

The drive element 14 includes a support plate 29 and a sabot 30. The sabot 30 includes a support boss 31 with a star shaped cross section that is supported in a pass through borehole 32 of the support plate 29 and that terminates in a stop 33. The storage container 3 is filled with water 34 up to a filling mark 8 in order to perform the method according to the invention and a tablet 35 pressed from plant components is inserted into the mixing chamber 13, the support plate 29 is interlocked with the mixing chamber 13 with a bayonet connection and the mixing unit 4 is placed onto the storage container 3 as shown in FIG. 2A/B and connected tightly with the storage container 3 by two clamps. The tablet 35 is approximately half submerged under a level 36 of the water 34 in the storage container 3.

When the drive 11 starts at a speed of 10,000 RPM, the pump 12 generates a vacuum in the initially air filled mixing chamber 13, wherein the vacuum sucks the water 34 out of the storage container 3 through the support plate 29 about the sabot 30 and through the mixing chamber 13 towards the comminuting element 26 and further towards the blades 24. The sabot 30 pulled in by the vacuum presses the tablet 35 against the comminuting element 26 that rotates with the pump wheel 17, wherein the teething of the comminuting element successively grinds down the tablet 35 and the plant parts and mechanically comminutes the tablet.

Water 34 flowing over the comminuting element 26 mixes with the plant parts and the mix is pressed through the filter by the blades 24 wherein the filter retains a pomace and only lets the suspension pass through. Coarse plant parts remain in the intermediary gap between the blades 24 and the filter and are mechanically comminuted further by the rotating pump wheel 17. The suspension flows through the pass through openings 20 radially outward from the housing 16 and runs downward into the storage container 3 and mixes with the water 34.

When the tablet 35 is ground down, the stop 33 contacts the support plate 29 and thus prevents damaging the sabot 30. Thus, the torque of the pump 12 decreases rapidly and the drive 11 is switched off automatically. The mixing unit 4 is disengaged from the storage container 3 and the ready to consume suspension can be dispensed from the storage container 3. In order to facilitate handling, the storage container 3 is closable by a lid that includes a pouring spout.

The device 1 and in particular the mixing unit 4 is disassembled into the individual components illustrated in FIG. 3A/B in order to clean the device 1.

The bayonet connection of the support plate 29 at the mixing chamber 13 is disengaged and the drive element 14 is separated from the mixing chamber 13 and the mixing chamber 13 is separated from the housing 16 through another bayonet connection. The comminuting element 26 connected by positive form locking with the spout of the pump wheel 17 and connected magnetically thereon is removed. The housing 16 is separated from the housing 9 by another bayonet connection, the filter is removed from the housing 16, the pump wheel 17 is pulled off from the drive 11 and the gasket 10 is removed from the housing 9.

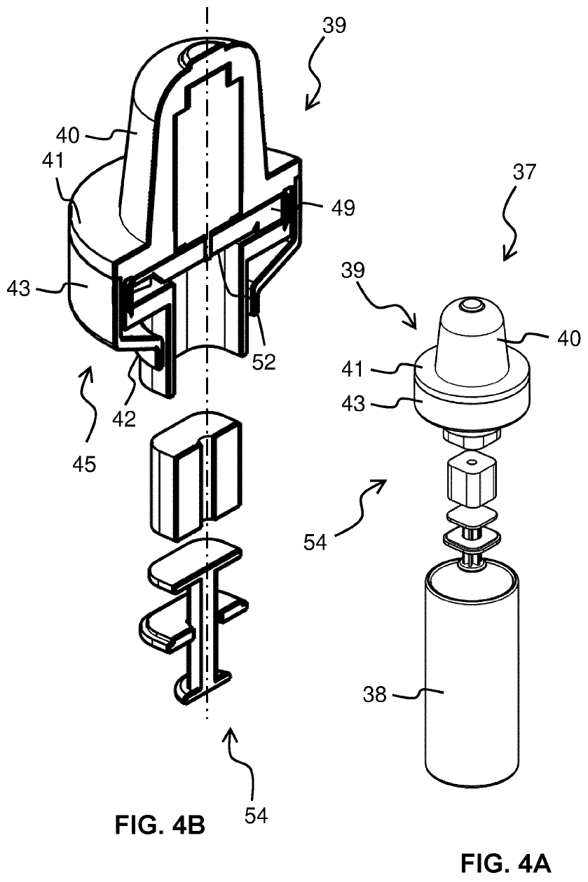

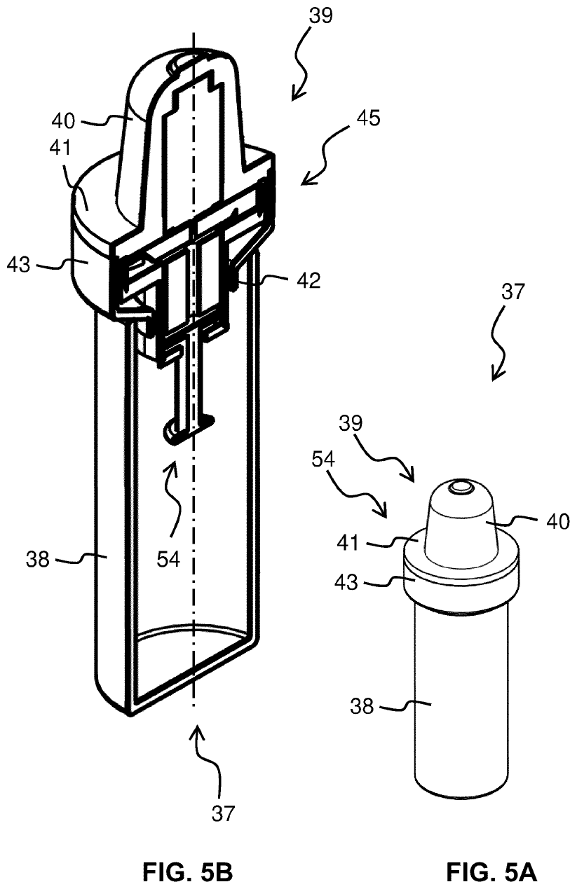

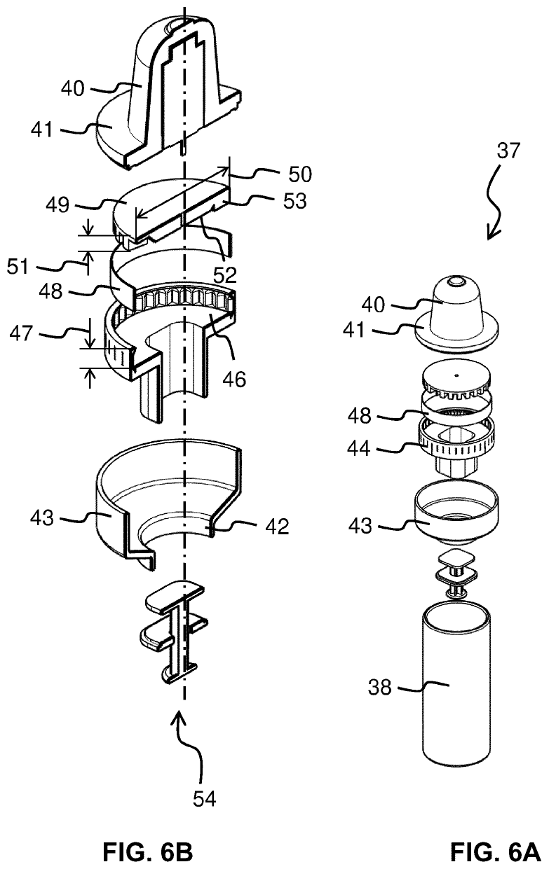

The second device 37 according to the invention shown in open condition in FIGS. 4A and 4B, in closed condition in FIGS. 5A and 5B and in individual components in FIGS. 6A and 6B corresponds in general to the first device 1, but differs therefrom in some details.

The storage container 38 is a straight circular cylinder. The two-piece housing 39 is made from a bell-shaped drive housing 40 which is expanded at a bottom like a hat by a wide brim 41, wherein an initially cylindrical, then conically tapering drain housing 43 that eventually terminates in a cylindrical spout 42 adjoins the brim 41.

The housing 44 of the pump 45 enclosed by the drain housing 43 has an inner diameter 46 of 104 mm and a height 47 of 13 mm. A filter 48 made from a stainless steel mesh is loosely inserted into the housing 44. The pump wheel 49 has a diameter 50 of 100 mm and a height 51 of 12 mms. The comminuting element 52 is integrated into the pump wheel 49, the blades 53 are arranged radially outside of the comminuting element.

Performing the method according to the invention using the second device 37 differs from performing the method with the first device 1 in several details: The mixing unit 54 is loosely placed onto the storage container 48 as shown in FIG. 5A/B without a seal element and the suspension flows from the housing 44 initially through the drain housing 43 back into the storage container 38. The drain housing 43 is separated from the drive housing 40 for cleaning as illustrated in FIG. 6A/B and the filter 48 is removed from the housing 44.

After cleaning the individual components under flowing water 34 or in a dish cleaner, the devices 1, 37 are reassembled in reverse order to be reused.

In other methods according to the invention, the devices 1, 37 are used to process loose coarse plant parts instead of the tablets 35, e.g. a mix of whole nuts, kernels, and almonds.

Other devices according to the invention essentially correspond to the devices 1, 37 recited supra, however they include an adaptor at the pump 11, 45 configured to receive a commercially available hand blender or a pass through opening in the sabot 30 or grooves on the sabot 30 for the water 34 or no sabot at all.

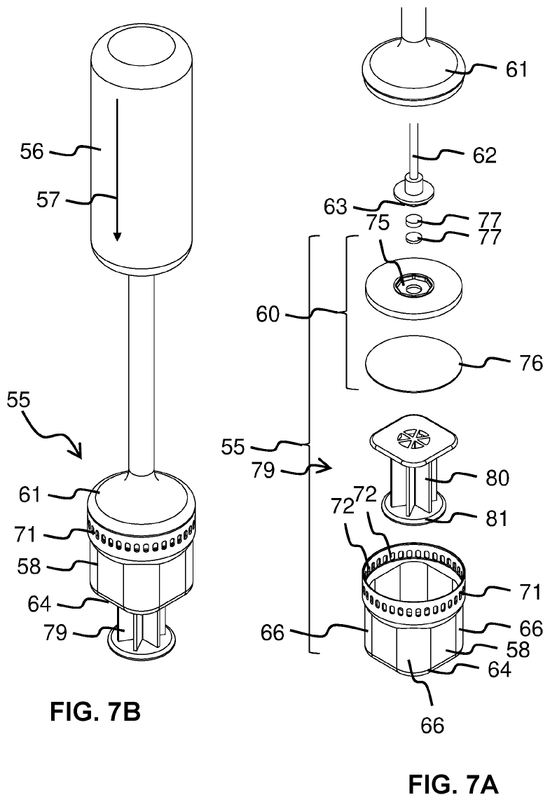

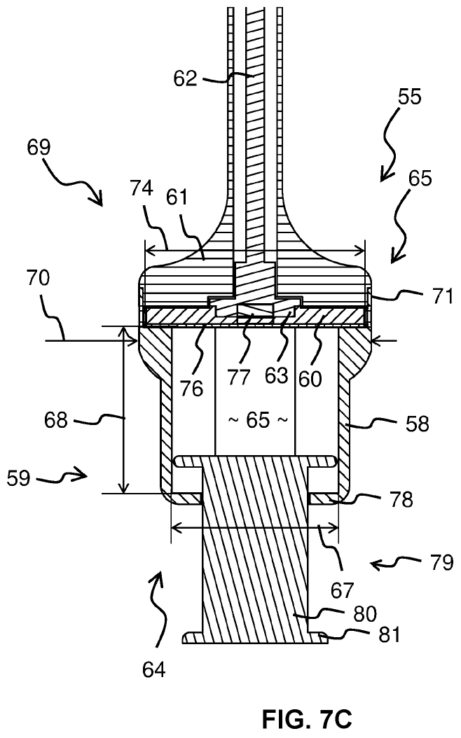

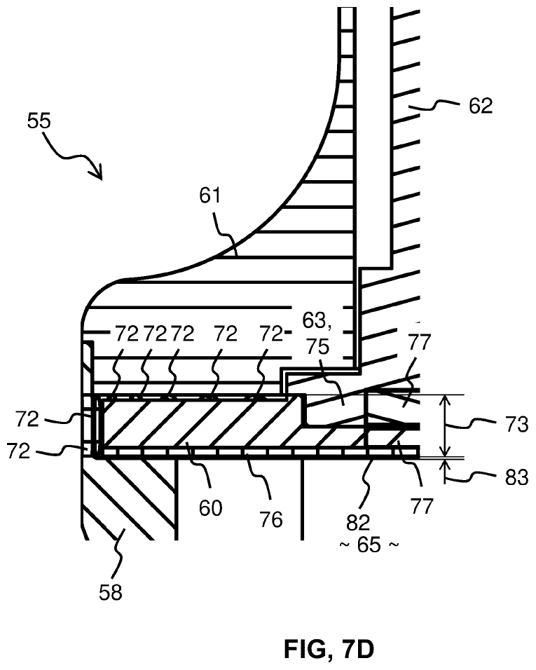

The third device 55 according to the invention illustrated in FIGS. 7 a-7 d is attached at a commercial hand blender 56. The third device 55 includes a rotation symmetric housing 58 arranged about a longitudinal direction 57 of the hand blender 56, a drive element 59 and a circular pump wheel 60 essentially made from synthetic material.

The hand blender 36 has a power of 600 W and is supplied with energy by a non-illustrated cable. A connection cover 61 of the hand blender 56 includes a circumferentially arranged bayonet closure. The connection cover 61 includes a drive shaft 62 arranged in the longitudinal direction 57 and supported in a boss 63, configured for torque-proof reception of standard accessories.

The housing 58 envelops a mixing chamber 65 that includes a square cross section arranged in the longitudinal direction 57 with an edge length 67 of 44 mm and a height 68 of 57 mm that is rounded at corners 66. The housing 58 is thickened to a diameter 70 of 65 mm at the topside 69 and transitions into a circular cylindrical collar 71. The collar 71 includes a rim of 32 vertically extending pass through openings 72 radially running outward and additionally includes a matching piece for the bayonet closure of the connection cover 61.

The pump wheel 60 has a thickness 73 of 4 mm and a diameter 74 of 60 mm, an octagonal recess 75 matching the boss 63 and a glued-on rasp 76 made from a zirconium ceramic material with a spiral teething. Zirconium magnets 77 are embedded in the recess 75 and in the spout 63, wherein the zirconium magnets 77 support the pump wheel 60 at the drive shaft 62 after attaching the device 55 at the hand blender 56.

The drive element 59 includes a support plate 78 terminating the housing 58 at a bottom and a sabot 79. The sabot 79 includes a support boss 80 with a start shaped cross section that is support by the support plates 78 and that terminates in a stop 81. The stop 81 prevents a separation of the sabot 79 from the housing 58.

In order to perform the method according to the invention a portion of plant parts is inserted into the housing 58 closed at a bottom side by the sabot 79. The pump wheel 60 is attached at the drive shaft 62 and the housing 58 is attached at the closing cover 61 and the device 55 is held underwater in a storage container. An annular gap 82 with a gap dimension 83 of 0.2 mm then remains between the rasp 76 and the housing 58.

Starting the hand blender 56 at a speed of 10,000 RPM, the pump wheel 60 generates a radial flow in the gap 62 and generates a vacuum in the mixing chamber 65, wherein the vacuum sucks the water out of the storage container through the bottom side 64 of the housing 58 about the sabot 79 and through the mixing chamber 65 to the pump wheel 60. The sabot 79 pulled in by the vacuum presses the plant parts against the rotating pump wheel 60 which functions as the comminuting element and successively grinds down and mechanically comminutes the plant parts.

Water flowing over the pump wheel 60 mixes with the comminuted plant parts. The mix is pulled through the gap 82 by the suction generated therein, wherein the gap 82 retains coarse plant parts in a pomace and only lets the suspension pass through. The suspension flows radially outward from the housing 58 through the pass through openings 72, flows back into the storage container and mixes with the water therein. The water, the plant parts, the suspension, and the pomace are not illustrated.

When the plant pars are ground down, the stop 81 contacts the bottom side of the housing 58 and thus prevents damaging the sabot 79. Therefore, the torque at the and blender decreases rapidly and the speed change provides an acoustic signal to perform the switch off. Thereafter the device 55 is removed from the storage container and the ready to drink suspension can be poured from the storage container. The storage container can include a pouring spout in order to facilitate handling.

In order to clean the device 55 the bayonet connection of the housing 58 at the connection cover 61 is disengaged and the pump wheel 60 is removed from the drive shaft 62, Pomace retained in the housing 58 is shaken out. After cleaning the individual components under running water or in a dish cleaner, the device 55 is reassembled in reverse order before being reused.

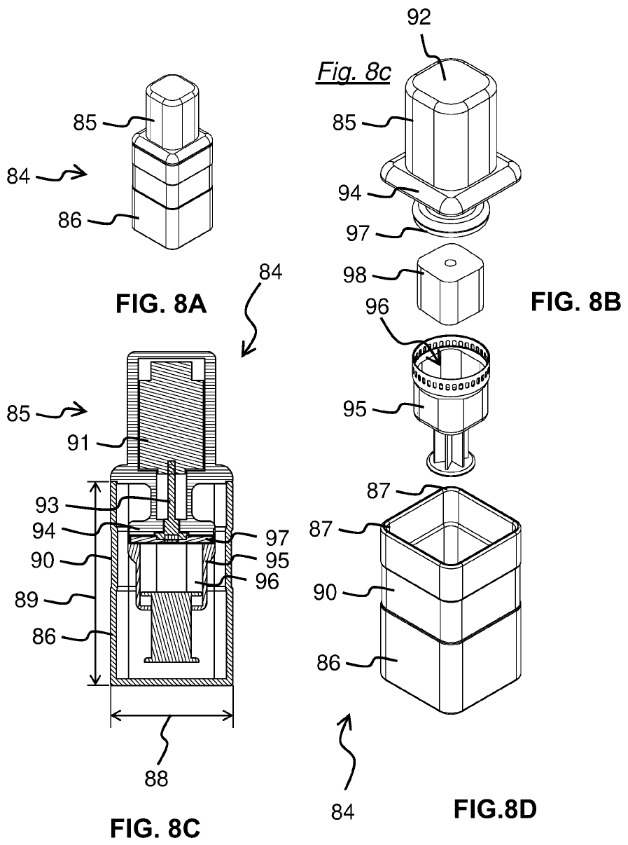

FIGS. 8A-8C show a fourth device 84 according to the invention, mostly corresponding to the third device 55, but including an integrated drive instead of the hand blender 56 and a straight cylindrical storage container 86 that is closable tight by the drive 85.

The storage container 86 includes a square cross section rounded at edges 87 with an edge length 88 of 90 mm, a height 89 of 150 mm, and a circumferential gripping recess 90 including a capacity of 500 ccm.

Another device according to the invention essentially corresponds to the 4th device 84 but includes a storage container with a height of 220 mm and a storage volume of 1,000 ccm.

The drive 85 includes an electric motor 91 with a power of 600 W, which is supplied with energy by a cable. A keying switch 92 configured to turn the drive on and off is arranged at the top of the drive 85. A drive shaft 93 of the electric motor is supported by a connection cover 94 for the housing 95 including the mixing chamber 96 at a bottom of the drive 85. The pump wheel 97 is removably attached at the drive shaft 93.

FIG. 8C illustrates an exemplary shape of a portion of plant parts pressed into a tablet 98. The method according to the invention processes tablets 98 or loose coarse plant parts, e.g. a mix of whole nuts, kernels, and almonds through the devices 55, 84 according to the invention.

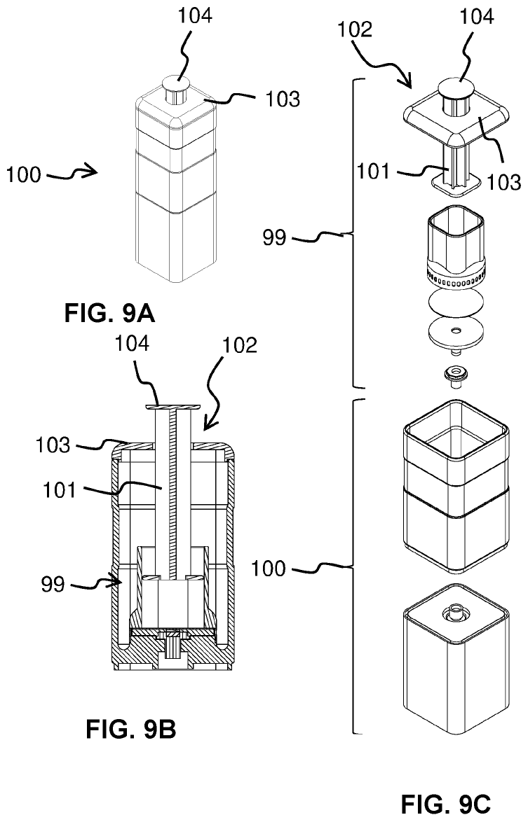

The fifth device 99 according to the invention illustrated in FIG. 9A-9C essentially corresponds to the third device 55, but is attached at a commercially available hand blender 100. The support boss 101 of the drive element 102 of the fifth device 99 is run outward through the cover 103 of the hand blender. The stop 104 contacts the cover 103 when the plant parts are ground down.

### REFERENCE NUMERALS AND DESIGNATIONS

1 device
2 vertical axis
3 storage container
4 mixing unit
5 recessed grip
6 rim
7 height
8 fill mark
9 housing
10 gasket
11 drive
12 pump
13 mixing chamber
14 drive element
15 keying switch
16 housing
17 pump wheel
18 diameter
19 height
20 pass through opening
21 diameter
22 height
23 plate
24 blade
25 boss
26 comminuting element
27 edge length
28 height
29 support plate
30 sabot
31 support boss
32 pass through opening
33 stop
34 water
35 tablet
36 level
37 device
38 storage container
39 housing
40 drive housing
41 brim
42 boss
43 drain housing
44 housing
45 pump
446 diameter
47 height
48 filter
49 pump wheel
50 diameter
51 height
52 comminuting element
53 blade
54 mixing unit
55 device
56 hand blender
57 longitudinal direction
58 housing
59 drive element
60 pump wheel
61 connection cover
62 drive shaft
63 boss
64 bottom side
65 mixing chamber
66 edge
67 edge length
68 height
69 topside
70 diameter
71 collar
72 pass through opening
73 thickness
74 diameter
75 recess
76 rasp
77 zirconium magnet
78 support plate
79 sabot
80 support boss
81 stop
82 gap
83 gap dimension
84 device
85 drive
86 storage container
87 edge
88 edge length
89 height
90 gripping recess
91 electric motor
92 keying switch
93 drive shaft
94 connection cover
95 housing
96 mixing chamber
97 pump wheel
98 tablet
99 device
100 hand blender
101 support boss
102 drive element
103 cover
104 stop

What is claimed is:

1. A method for producing a suspension, the method comprising:
feeding water by a pump from a storage container through a mixing chamber;
mechanically comminuting plant parts from real nuts, kernels, grains, and/or seeds by a comminuting element to form comminuted plat parts;
mixing the comminuted plant parts with the water in the mixing chamber to form a mix;
pressing the mix through a filter that passes the suspension through and retains a pomace that remains from the plant parts,
wherein a pump wheel of the pump forms the comminuting element.

2. The method according to claim 1, wherein the suspension flows from the mixing chamber into a capture container.

3. The method according to claim 1, wherein the storage container is the capture container.

4. The method according to claim 1, further comprising:
pressing the plant parts into a shape of a tablet and drying the tablet;
introducing the tablet into the mixing chamber; and
comminuting the tablet by the comminuting element.

5. A device for producing a suspension, the device comprising:
a comminuting element configured to comminute plant parts from real nuts, kernels, grains, and/or other seeds into comminuted plant parts;
a mixing chamber configured to mix the comminuted plant parts with water;
a filter configured to pass the suspension through and retain a pomace remaining from the plant parts;
a pump configured to press the water from a storage container through the mixing chamber and the filter,
wherein a pump wheel of the pump forms the comminuting element.

6. The device according to claim 5, wherein the comminuting element is a rasp.

7. The device according to claim 5, wherein the filter is a gap with a gap dimension of 0.5 mm at the most, or 0.2 mm at the most.

8. The device according to claim 7, wherein the pump wheel defines the gap.

9. The device according to claim 5, wherein the mixing chamber has a constant, at the most sextuple rotation symmetrical cross section in a vertical axial direction.

10. The device according to claim 5, further comprising: a drive element axially movable in the mixing chamber and substantially closing the mixing chamber below the plant parts.

11. The device according to claim 5, wherein a drive, a housing including the mixing chamber, the pump wheel, and/or the storage container are connected by disengage-able connections configured as snapped-, clamped-, magnet-, or bayonet-connections.
